(19) United States
(12) Patent Application Publication
(10) Pub. No.: US 2025/0079514 A1
(43) Pub. Date: Mar. 6, 2025

(54) SILYL ENOLATES FOR USE IN LITHIUM BATTERY ELECTROLYTES

(71) Applicant: UCHICAGO ARGONNE, LLC, Chicago, IL (US)

(72) Inventors: Chi Cheung Su, Westmont, IL (US); Khalil Amine, Oakbrook, IL (US)

(73) Assignee: UCHICAGO ARGONNE, LLC, Chicago, IL (US)

(21) Appl. No.: 18/239,838

(22) Filed: Aug. 30, 2023

(51) Int. Cl. H01M 10/0567; C07F 7/18; H01M 10/0525; H01M 10/42

(52) U.S. Cl. CPC H01M 10/0567; C07F 7/1804; H01M 10/0525; H01M 10/4235; H01M 2300/0025

(57) ABSTRACT

A non-aqueous electrolyte comprising a salt, a non-aqueous solvent, and a compound of Formula (I) or Formula (II) or Formula (III) or Formula (IV) or Formula (V):

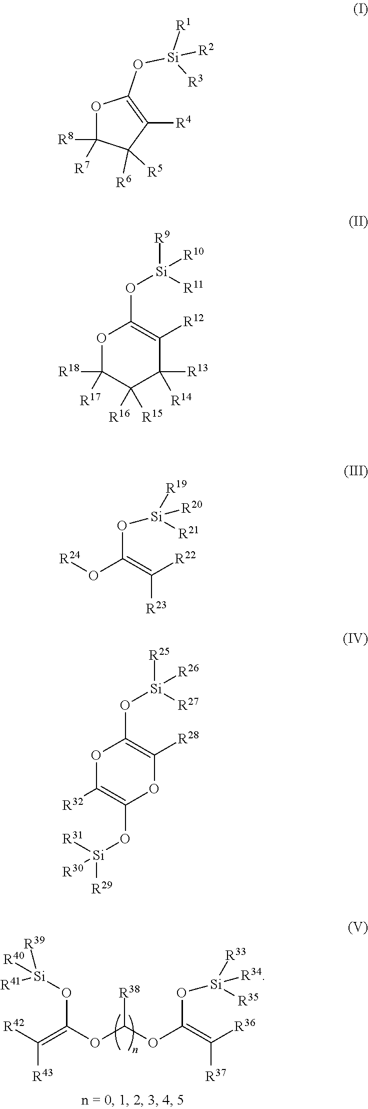

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The technology generally relates to lithium rechargeable batteries. More particularly the technology relates to the use of silyl enolate compounds in electrochemical cells and batteries.

### BACKGROUND

Lithium-ion batteries are widely used as energy sources for portable electronics and hybrid electric vehicles. To realize the application of pure electric vehicles, lithium-ion batteries with high energy density are crucial, and novel anode and cathode materials with high energy density are actively pursued.

However, it has been found that battery performance fades rapidly at higher and higher operating potentials due, at least in part, to parasitic reactions between electrolytes and the surfaces of the cathodes that used. New electrolytes or electrolyte additives are, therefore, needed to prevent or minimize the parasitic reactions that lead to battery degradation.

### SUMMARY

In one aspect, a non-aqueous electrolyte includes a salt; and a compound of Formula (I), Formula (II), Formula (III), Formula (IV), Formula (V), or a mixture of any two or more thereof. In the electrolyte the Formulae are:

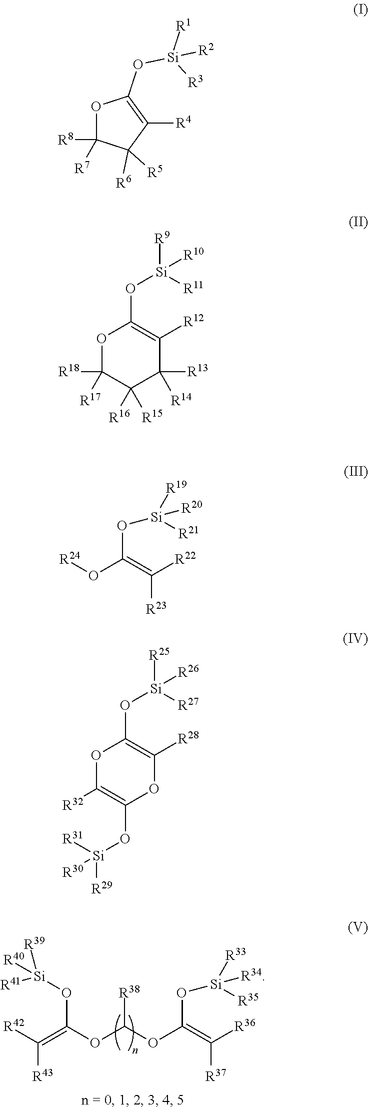

In the formulae above, R¹, R², R³, R⁹, R¹⁰, R¹¹, R¹⁹, R²⁰, R²¹, R²⁵, R²⁶, R²⁷, R²⁹, R³⁰, R³¹, R³³, R³⁴, R³⁵, R³⁸, R³⁹, R⁴⁰, and R⁴¹ are individually H, F, alkyl, alkenyl, alkynyl, aryl, aralkyl, heteroaryl, heteroarylalkyl, heterocyclylalkyl, heterocyclylalkyl, cycloalkyl, cycloalkylalkyl, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂. In the formulae above, R⁴, R⁵, R⁶, R⁷, R⁸; R¹², R¹³, R¹⁴, R¹⁵, R¹⁶, R¹⁷, R¹⁸, R²², R²³, R²⁴, R²⁸, R³², R³⁶, R³⁷, R³⁸, R⁴², and R⁴³ are individually H, F, alkyl, alkenyl, alkynyl, aryl, aralkyl, heteroaryl, heteroarylalkyl, heterocyclylalkyl, heterocyclylalkyl, cycloalkyl, cycloalkylalkyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂.

In various embodiments of the formulae above, each R^{y} (where R^{y} indicates any of R¹, R², R³, R⁹, R¹⁰, R¹¹, R¹⁹, R²⁰, R²¹, R²⁵, R²⁶, R²⁷, R²⁹, R³⁰, R³¹, R³³, R³⁴, R³⁵, R³⁸, R³⁹, R⁴⁰, and R⁴¹) may individually be H, —C(O)R⁷⁰, alkyl, aryl, aralkyl, heteroaryl, heterocyclyl, alkenyl, alkynyl, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and each R^{x} (where R^{x} indicates any of R⁴, R⁵, R⁶, R⁷, R⁸; R¹², R¹³, R¹⁴, R¹⁵, R¹⁶, R¹⁷, R¹⁸, R²², R²³, R²⁴, R²⁸, R³², R³⁶, R³⁷, R³⁸, R⁴², and R⁴³) may individually be H, alkyl, aryl, aralkyl, heteroaryl, heterocyclyl, alkenyl, alkynyl, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂. In the above formulas, R⁷⁰ may be H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂.

In some embodiments, where the compound is of Formula (I), R¹, R², and R³ may be C₁₋₆ alkyl, —(CR⁷¹₂)ₚO(C₁-C₆ alkyl), —(CR⁷¹₂)ₚO(C₁-C₆ aryl), or —(CR⁴⁴₂)ₚO(C₁-C₆ aralkyl); R⁴, R⁵, R⁶, R⁷, and R⁸ may be each H, F, OR⁷², or C₁₋₆ alkyl; each R⁷¹ may be individually H or F; R⁷² may be H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and p may be 1, 2, or 3. In some embodiments, R¹, R², and R³ may be methyl, ethyl, or benzyl; and R⁴, R⁵, R⁶, R⁷, and R⁸ are each H. In further embodiments, R¹, R², and R³ may be C₁₋₆ fluorinated alkyl, C₁₋₆ fluorinated alkenyl, or C₁₋₆ fluorinated alkynyl; and R⁴, R⁵, R⁶, R⁷, and R⁸ are C₁₋₆ fluorinated alkyl or H. In the above formulas, R⁷⁰ may be H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂.

In some embodiments, where the compound is of Formula (II), R⁹, R¹⁰, and R¹¹ may be C₁₋₆ alkyl, —(CR⁷¹₂)ₚO(C₁-C₆ alkyl), —(CR⁷¹₂)ₚO(C₁-C₆ aryl), or —(CR⁷¹₂)ₚO(C₁-C₆ aralkyl); R¹², R¹³, R¹⁴, R¹⁵, R¹⁶, R¹⁷, and R¹⁸ may be each H, F, OR⁷², or C₁₋₆ alkyl; each R⁷¹ may be individually H or F R⁷² may be H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and p may be 1, 2, or 3. In some embodiments, R⁹, R¹⁰, and R¹¹ may be methyl, ethyl, or benzyl; and R¹², R¹³, R¹⁴, R¹⁵, R¹⁶, R¹⁷, and R¹⁸ are each H. In further embodiments, R⁹, R¹⁰, and R¹¹ may be C₁₋₆ fluorinated alkyl, C₁₋₆ fluorinated alkenyl, or C₁₋₆ fluorinated alkynyl; and R¹², R¹³, R¹⁴, R¹⁵, R¹⁶, R¹⁷, and R¹⁸ are C₁₋₆ fluorinated alkyl or H. In the above formulas, R⁷⁰ may be H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂.

In some embodiments, where the compound is of Formula (III), R¹⁹, R²⁰, and R²¹ may be C₁₋₆ alkyl, —(CR⁷¹₂)ₚO(C₁-C₆ alkyl), —(CR⁷¹₂)ₚO(C₁-C₆ aryl), or —(CR⁷¹₂)ₚO(C₁-C₆ aralkyl); R²², R²³, and R²⁴ may be each H, F, OR⁷², or C₁₋₆ alkyl; each R⁷¹ may be individually H or F; R⁷² may be H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and p may be 1, 2, or 3. In some embodiments, R¹⁹, R²⁰, and R²¹ may be methyl, ethyl, or benzyl; and R²², R²³, and R²⁴ are each H. In a further embodiment, R¹⁹, R²⁰, and R²¹ may be C₁₋₆ fluorinated alkyl, C₁₋₆ fluorinated alkenyl, or C₁₋₆ fluorinated alkynyl; and R²², R²³, and R²⁴ are C₁₋₆ fluorinated alkyl or H. In the above formulas, R⁷⁰ may be H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂.

In some embodiments, where the compound is of Formula (IV), R²⁵, R²⁶, R²⁷, R²⁹, R³⁰, and R³¹ may be C₁₋₆ alkyl, —(CR⁷¹₂)ₚO(C₁-C₆ alkyl), —(CR⁷¹₂)ₚO(C₁-C₆ aryl), or —(CR⁷¹₂)ₚO(C₁-C₆ aralkyl); R²⁸ and R³² may be each H, F, OR⁷², or C₁₋₆ alkyl; each R⁷¹ may be individually H or F; R⁷² may be H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and p may be 1, 2, or 3. In some embodiments, R²⁵, R²⁶, R²⁷, R²⁹, R³⁰, and R³¹ may be methyl, ethyl, or benzyl; and R²⁸ and R³² are each H. In a further embodiment, R²⁵, R²⁶, R²⁷, R²⁹, R³⁰, and R³¹ may be C₁₋₆ fluorinated alkyl, C₁₋₆ fluorinated alkenyl, or C₁₋₆ fluorinated alkynyl; and R²⁸ and R³² are C₁₋₆ fluorinated alkyl or H. In the above formulas, R⁷⁰ may be H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂.

In some embodiments, where the compound may be of Formula (V), R³³, R³⁴, R³⁵, R³⁸, R³⁹, R⁴⁰, and R⁴¹ may be C₁₋₆ alkyl, —(CR⁷¹₂)ₚO(C₁-C₆ alkyl), —(CR⁷¹₂)ₚO(C₁-C₆ aryl), or —(CR⁷¹₂)ₚO(C₁-C₆ aralkyl); R³⁶, R³⁷, R⁴², and R⁴³ may be each H, F, OR⁷², or C₁₋₆ alkyl; each R⁷¹ may be individually H or F; R⁷² may be H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and p may be 1, 2, or 3. In some embodiments, R³³, R³⁴, R³⁵, R³⁸, R³⁹, R⁴⁰, and R⁴¹ may be methyl, ethyl, or benzyl; and R³⁶, R³⁷, R⁴², and R⁴³ are each H. In a further embodiment, R³³, R³⁴, R³⁵, R³⁸, R³⁹, R⁴⁰, and R⁴¹ may be C₁₋₆ fluorinated alkyl, C₁₋₆ fluorinated alkenyl, or C₁₋₆ fluorinated alkynyl; and R³⁶, R³⁷, R⁴², and R⁴³ are C₁₋₆ fluorinated alkyl or H. In the above formulas, R⁷⁰ may be H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂.

In another aspect, an electrochemical cell includes an anode, a cathode, and a non-aqueous electrolyte that includes a salt, a non-aqueous solvent, and from greater than 0 wt % to about 20 wt % of a compound of Formula (I), Formula (II), Formula (III), Formula (IV), Formula (V), as described in any of the above embodiments.

### BRIEF DESCRIPTION OF THE DRAWINGS

FIG. 1 presents linear sweep voltammograms for 1.2 M LiFSI EMS (lithium bis(fluorosulfonyl)imide in ethylmethyl sulfone; 1.2 M LiFSI EMS with 2 wt. % gamma butyrolactone (“GBL”); and 1.2 M LiFSI EMS with 2 wt. % GBLTMS (((4,5-dihydrofuran-2-yl)oxy)trimethylsilane), using a 2023 coin cell system (aluminum working electrode, lithium counter electrode and reference electrode), according to Example 3.

FIG. 2 is a discharge capacity vs. cycle number graph for cells based on LiNi_{0.8}Mn_{0.1}Co_{0.1}O₂ (NMC811)/A12 graphite, and electrolytes containing 1.2 M LiFSI EMS; and 1.2 M LiFSI EMS with 2 wt. % GBLTMS, according to Example 4. The cells were cycled from 3.0 V to 4.5 V at a current of C/2.

FIG. 3 is a discharge capacity vs. cycle number graph for cells based on LiNi_{0.8}Mn_{0.1}Co_{0.1}O₂ (NMC811)/A12 graphite, and electrolytes containing 1.2 M LiFSI EMS; and 1.2 M LiFSI EMS with 2 wt. % OMeOTMSPE (((1-methoxyprop-1-en-1-yl)oxy)trimethylsilane), according to Example 5. The cells were cycled from 3.0 V to 4.5 V at a current of C/2.

FIG. 4 is a discharge capacity vs. cycle number graph for cells based on LiNi_{0.8}Mn_{0.1}Co_{0.1}O₂ (NMC811)/A12 graphite, and electrolytes containing 1.2 M LiFSI EMS; 1.2M LiPF6 EC/EMC 3/7; 1.2 M LiFSI EMS with 2 wt. % GBLTMS; and 1.2 M LiFSI EMS with 2 wt. % GBLTMS plus 2 wt. % TFDTD ((3-(trifluoromethyl)tetrahydrothiophene), according to Example 6. The cells were cycled from 3.0 V to 4.5 V at a current of C/2.

FIG. 5 is a discharge capacity vs. cycle number graph for cells based on LiNi_{0.8}Mn_{0.1}Co_{0.1}O₂ (NMC811)/A12 graphite, and electrolytes containing 1.2 M LiFSI EMS; 1.2 M LiFSI EMS with 2 wt. % TFDTD; 1.2 M LiFSI EMS with 2 wt. % GBL plus 2 wt. % TFDTD; and 1.2 M LiFSI EMS with 2 wt. % GBLTMS plus 2 wt. % TFDTD, according to Example 7. The cells were cycled from 3.0 V to 4.5 V at a current of C/2.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, the following definitions of terms shall apply unless otherwise indicated.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The embodiments, illustratively described herein may suitably be practiced in the absence of any element or elements, limitation, or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In general, “substituted” refers to a group, as defined below (e.g., an alkyl or aryl group) in which one or more bonds to a hydrogen atom contained therein are replaced by a bond to non-hydrogen and non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, carbonyls(oxo), carboxyls, esters, urethanes, thiols, sulfides, sulfoxides, sulfones, sulfonyls, sulfonamides, amines, isocyanates, isothiocyanates, cyanates, thiocyanates, nitro groups, nitriles (i.e., CN), and the like. Reference to any such groups, for example, “an alkyl or an aryl,” includes both substituted and unsubstituted versions, unless one or the other is expressly stated.

Alkyl groups include straight chain and branched alkyl groups having from 1 to 20 carbon atoms or, in some embodiments, from 1 to 12, 1 to 8, 1 to 6, or 1 to 4 carbon atoms. Alkyl groups further include cycloalkyl groups. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative alkyl groups may be unsubstituted, or substituted one or more times with substituents such as those listed above. Where the term haloalkyl is used, the alkyl group is substituted with one or more halogen atoms.

Cycloalkyl groups are cyclic alkyl groups (as are considered to be a subset of alkyl) such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Cycloalkyl groups further include mono-, bicyclic and polycyclic ring systems, such as, for example bridged cycloalkyl groups as described below, and fused rings, such as, but not limited to, decalinyl, and the like. In some embodiments, polycyclic cycloalkyl groups have three rings. Cycloalkyl groups may be unsubstituted or substituted one or more times with, non-hydrogen, non-carbon groups as defined above. However, substituted cycloalkyl groups also include rings that are substituted with straight or branched chain alkyl groups as defined above. Representative substituted cycloalkyl groups may be mono-substituted or substituted more than once, such as, but not limited to, 2,2-, 2,3-, 2,4-2,5- or 2,6-disubstituted cyclohexyl groups, which may be substituted with substituents such as those listed above.

Alkenyl groups include straight and branched chain and cycloalkyl groups as defined above, except that at least one double bond exists between two carbon atoms. Thus, alkenyl groups have from 2 to about 20 carbon atoms, and typically from 2 to 12 carbons or, in some embodiments, from 2 to 8, 2 to 6, or 2 to 4 carbon atoms. In some embodiments, alkenyl groups include cycloalkenyl groups having from 4 to 20 carbon atoms, 5 to 20 carbon atoms, 5 to 10 carbon atoms, or even 5, 6, 7, or 8 carbon atoms. Examples include, but are not limited to vinyl, allyl, CH═CH(CH₃), CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl, among others. Alkenyl groups may be unsubstituted or they may be mono-substituted or substituted more than once, such as, but not limited to, di- or tri-substituted with substituents such as those listed above.

Alkynyl groups include straight and branched chain alkyl groups, except that at least one triple bond exists between two carbon atoms. Thus, alkynyl groups have from 2 to about 20 carbon atoms, and typically from 2 to 12 carbons or, in some embodiments, from 2 to 8, 2 to 6, or 2 to 4 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃), among others. Representative alkynyl groups may be unsubstituted or mono-substituted or substituted more than once, such as, but not limited to, di- or tri-substituted with substituents such as those listed above.

Aryl, or arene, groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. Although the phrase “aryl groups” includes groups containing fused rings, such as fused aromatic-aliphatic ring systems (e.g., indanyl, tetrahydronaphthyl, and the like), it does not include aryl groups that have other groups, such as alkyl or halo groups, bonded to one of the ring members. Rather, groups such as tolyl are referred to as substituted aryl groups. Aryl groups may be unsubstituted, or mono-substituted or substituted more than once. For example, monosubstituted aryl groups include, but are not limited to, 2-, 3-, 4-, 5-, or 6-substituted phenyl or naphthyl groups, which may be substituted with substituents such as those listed above.

“Alkoxy” refers to the group —O-alkyl wherein alkyl is defined herein. Alkoxy includes, by way of example, methoxy, ethoxy, n-propoxy, isopropoxy, n-butoxy, t-butoxy, sec-butoxy, and n-pentoxy.

In one aspect, a non-aqueous electrolyte includes a salt; and a compound of Formula (I), Formula (II), Formula (III), Formula (IV), Formula (V) or a mixture of any two or more thereof. In the electrolyte the Formulae are:

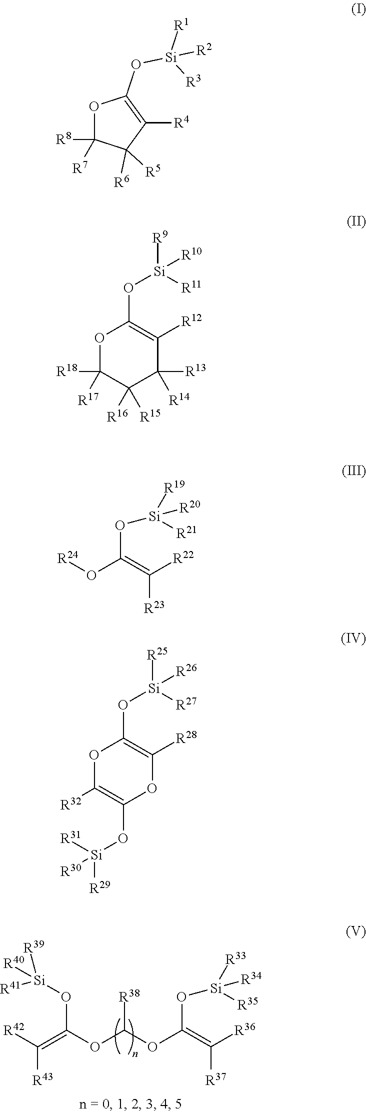

In the formulae above, R¹, R², R³, R⁹, R¹⁰, R¹¹, R¹⁹, R²⁰, R²¹, R²⁵, R²⁶, R²⁷, R²⁹, R³⁰, R³¹, R³³, R³⁴, R³⁵, R³⁸, R³⁹, R⁴⁰, and R⁴¹ are individually H, F, alkyl, alkenyl, alkynyl, aryl, aralkyl, heteroaryl, heteroarylalkyl, heterocyclylalkyl, heterocyclylalkyl, cycloalkyl, cycloalkylalkyl, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂. In the formulae above, R⁴, R⁵, R⁶, R⁷, R⁸; R¹², R¹³, R¹⁴, R¹⁵, R¹⁶, R¹⁷, R¹⁸, R²², R²³, R²⁴, R²⁸, R³², R³⁶, R³⁷, R⁴², and R⁴³ are individually H, F, alkyl, alkenyl, alkynyl, aryl, aralkyl, heteroaryl, heteroarylalkyl, heterocyclylalkyl, heterocyclylalkyl, cycloalkyl, cycloalkylalkyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂.

In some embodiments, the compound is that of Formula (I). Where the compound is of Formula (I), in some embodiments, R¹, R², and R³ may be individually C₁₋₆ alkyl, —(CR⁷¹₂)ₚO(C₁-C₆ alkyl), —(CR⁷¹₂)ₚO(C₁-C₆ aryl), or —(CR^{w}₂)ₚO(C₁-C₆ aralkyl); R⁴, R⁵, R⁶, R⁷, and R⁸ may be each H, F, OR⁷², or C₁₋₆ alkyl; each R⁷¹ may be individually H or F; R⁷² may be H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; R⁷⁰ may be H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and p may be 1, 2, or 3. In other embodiments, R¹, R², and R³ may be individually methyl, ethyl, or benzyl; and R⁴, R⁵, R⁶, R⁷, and R⁸ may be each H. Alternatively, R¹, R², and R³ may be individually may be C₁₋₆ fluorinated alkyl, C₁₋₆ fluorinated alkenyl, or C₁₋₆ fluorinated alkynyl; and R⁴, R⁵, R⁶, R⁷, and R⁸ may be C₁₋₆ fluorinated alkyl or H. In yet other embodiments, R¹, R², and R³ may be —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃; and R⁴, R⁵, R⁶, R⁷, and R⁸ may be individually H, —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃.

In some embodiments, the compound is that of Formula (II). Where the compound is of Formula (II), in some embodiments, R⁹, R¹⁰, and R¹¹ may be individually C₁₋₆ alkyl, —(CR⁷¹₂)ₚO(C₁-C₆ alkyl), —(CR⁷¹₂)ₚO(C₁-C₆ aryl), or —(CR⁷¹₂)ₚO(C₁-C₆ aralkyl); R¹², R¹³, R¹⁴, R¹⁵, R¹⁶, R¹⁷, and R¹⁸ may be each H, F, OR⁷², or C₁₋₆ alkyl; each R⁷¹ may be individually H or F; R⁷² may be H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; R⁷⁰ may be H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and p may be 1, 2, or 3. In other embodiments, R⁹, R¹⁰, and R¹¹ may be individually methyl, ethyl, or benzyl; and R¹², R¹³, R¹⁴, R¹⁵, R¹⁶, R¹⁷, and R¹⁸ may be each H. Alternatively, R⁹, R¹⁰, and R¹¹ may be individually may be C₁₋₆ fluorinated alkyl, C₁₋₆ fluorinated alkenyl, or C₁₋₆ fluorinated alkynyl; and R¹², R¹³, R¹⁴, R¹⁵, R¹⁶, R¹⁷, and R¹⁸ may be C₁₋₆ fluorinated alkyl or H. In yet other embodiments, R⁹, R¹⁰, and R¹¹ may be —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃; and R¹², R¹³, R¹⁴, R¹⁵, R¹⁶, R¹⁷, and R¹⁸ may be individually H, —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃.

In some embodiments, the compound is that of Formula (III). Where the compound is of Formula (III), in some embodiments, R¹⁹, R²⁰, and R²¹ may be individually C₁₋₆ alkyl, —(CR⁷¹₂)ₚO(C₁-C₆ alkyl), —(CR⁷¹₂)ₚO(C₁-C₆ aryl), or —(CR⁷¹₂)ₚO(C₁-C₆ aralkyl); R²², R²³, and R²⁴ may be each H, F, OR⁷², or C₁₋₆ alkyl; each R⁷¹ may be individually H or F; R⁷² may be H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; R⁷⁰ may be H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and p may be 1, 2, or 3. In other embodiments, R¹⁹, R²⁰, and R²¹ may be individually methyl, ethyl, or benzyl; and R²², R²³, and R²⁴ may be each H. Alternatively, R¹⁹, R²⁰, and R²¹ may be individually may be C₁₋₆ fluorinated alkyl, C₁₋₆ fluorinated alkenyl, or C₁₋₆ fluorinated alkynyl; and R²², R²³, and R²⁴ may be C₁₋₆ fluorinated alkyl or H. In yet other embodiments, R¹⁹, R²⁰, and R²¹ may be —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃; and R²², R²³, and R²⁴ may be individually H, —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃.

In some embodiments, the compound is that of Formula (IV). Where the compound is of Formula (IV), in some embodiments, R²⁵, R²⁶, R²⁷, R²⁹, R³⁰, and R³¹ may be individually C₁₋₆ alkyl, —(CR⁷¹₂)ₚO(C₁-C₆ alkyl), —(CR⁷¹₂)ₚO(C₁-C₆ aryl), or —(CR⁷¹₂)ₚO(C₁-C₆ aralkyl); R²⁸, and R³² may be each H, F, OR⁷², or C₁₋₆ alkyl; each R⁷¹ may be individually H or F; R⁷² may be H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; R⁷⁰ may be H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and p may be 1, 2, or 3. In other embodiments, R²⁵, R²⁶, R²⁷, R²⁹, R³⁰, and R³¹ may be individually methyl, ethyl, or benzyl; and R²⁸ and R³² may be each H. Alternatively, R²⁵, R²⁶, R²⁷, R²⁹, R³⁰, and R³¹ may be individually may be C₁₋₆ fluorinated alkyl, C₁₋₆ fluorinated alkenyl, or C₁₋₆ fluorinated alkynyl; and R²⁸ and R³² may be C₁₋₆ fluorinated alkyl or H. In yet other embodiments, R²⁵, R²⁶, R²⁷, R²⁹, R³⁰, and R³¹ may be —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃; and R²⁸ and R³² may be individually H, —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃.

In some embodiments, the compound is that of Formula (V). Where the compound is of Formula (V), in some embodiments, R³³, R³⁴, R³⁵, R³⁸, R³⁹, R⁴⁰, and R⁴¹ may be individually C₁₋₆ alkyl, —(CR⁷¹₂)ₚO(C₁-C₆ alkyl), —(CR⁷¹₂)ₚO(C₁-C₆ aryl), or —(CR⁷¹₂)ₚO(C₁-C₆ aralkyl); R³⁶, R³⁷, R⁴², and R⁴³ may be each H, F, OR⁷², or C₁₋₆ alkyl; each R⁷¹ may be individually H or F; R⁷² may be H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; R⁷⁰ may be H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and p may be 1, 2, or 3. In other embodiments, R³³, R³⁴, R³⁵, R³⁸, R³⁹, R⁴⁰, and R⁴¹ may be individually methyl, ethyl, or benzyl; and R³⁶, R³⁷, R⁴², and R⁴³ may be each H, Alternatively, R³³, R³⁴, R³⁵, R³⁸, R³⁹, R⁴⁰, and R⁴¹ may be individually may be C₁₋₆ fluorinated alkyl, C₁₋₆ fluorinated alkenyl, or C₁₋₆ fluorinated alkynyl; and R³⁶, R³⁷, R⁴², and R⁴³ may be C₁₋₆ fluorinated alkyl or H. In yet other embodiments, R³³, R³⁴, R³⁵, R³⁸, R³⁹, R⁴⁰, and R⁴¹ may be —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃; and R³⁶, R³⁷, R⁴², and R⁴³ may be individually H, —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃.

In some embodiments, the electrolyte also includes a non-aqueous solvent, and the compound of Formula (I)-(V) is added at additive (i.e. low) concentration to form the SEI layer. Where the compound is included at additive levels in the electrolyte, the compound may be present in the electrolyte from greater than 0 wt % up to about 20 wt %, based upon the total weight of the electrolyte, with the balance being the non-aqueous solvent, salt, and other optional additives that may be present. This includes from about 2 wt % to about 15 wt % of the compound of Formula (I)-(V), or from about 5 wt % to about 12 wt % of the compound of Formula (I)-(V). In some embodiments where the compound of Formula (I)-(V) is included at additive levels it is from about 0.01 wt % to about 10 wt %.

Where the electrolyte further includes a non-aqueous solvent, it may be a carbonate, a sulfone, a siloxane, a silane, an ether, an ester, a lactone, ionic liquid, any fluorinated derivatives thereof, or a blend of any two or more such solvents. For example, the solvent may include one or more of dimethyl carbonate, ethyl methyl carbonate, diethyl carbonate, methyl propyl carbonate, ethyl propyl carbonate, dipropyl carbonate, dimethoxyethane, triglyme, propylene carbonate, dimethylvinylene carbonate, tetraethyleneglycol, dimethyl ether, polyethylene glycols, γ-butyrolactone, ethylene carbonate, DFEC, FEMC, bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, or perfluorobutyl ethyl carbonate, as well as fluorinated solvents and fluorinated version of any of the foregoing solvents with being just two examples. In some embodiments, the non-aqueous solvent is one or more PC, EC, EMC, DFEC, or FEMC. In some embodiments, the solvent is a piperidinium-based ionic liquid or an imidazolium-based ionic liquid.

The salt that is used in the electrolyte may be a lithium, sodium, magnesium, calcium, or ammonium salt, or other salt as may be appropriate to the particular anode, cathode, or other cell chemistry that is being employed. In some embodiments, the salt may be a lithium salt for use in a lithium ion battery. Such salts may include, but are not limited to Li[CF₃CO₂]; Li[C₂F₅CO₂]; Li[ClO₄]; Li[BF₄]; Li[AsF₆]; Li[PF₆]; Li[PF₂(C₂O₄)₂]; Li[PF₄C₂O₄]; Li[CF₃SO₃]; Li[N(CF₃SO₂)₂]; Li[C(CF₃SO₂)₃]; Li[N(SO₂C₂F₅)₂]; lithium alkyl fluorophosphates; Li[B(C₂O₄)₂]; Li[BF₂C₂O₄]; Li₂[B₁₂X₁₂₋ₖHₖ]; and Li₂[B₁₀X_{10-k′}H_{k′}]. In such salts, X may be OH, F, Cl, or Br; k may be an integer from 0 to 12; and k′ may be an integer from 0 to 10. In some embodiments, the salt may be a sodium salt for use in a sodium ion battery. Such salts may include, but are not limited to Na(CF₃CO₂); Na(C₂F₅CO₂); NaClO₄; NaBF₄; NaAsF₆; NaPF₆; NaPF₂(C₂O₄)₂; NaPF₄(C₂O₄); NaCF₃SO₃; NaCH₃SO₃; NaN(SO₂CF₃)₂; NaC(CF₃SO₂)₃; NaN(SO₂C₂F₅)₂; sodium alkyl fluorophosphates; sodium alkyl fluoroborates; sodium 4,5-dicyano-2-(trifluoromethyl)imidazole; sodium 4,5-dicyano-2-methylimidazole; trisodium 2,2′,2″-tris(trifluoromethyl)benzotris(imidazolate); NaB(C₂O₄)₂; NaBF₂(C₂O₄)₂; Na₂(B₁₂X₁₂₋ₖHₖ); and Na₂(B₁₀X_{10-k′}H_{k′}). In such salts, X may be OH, F, Cl, or Br; k may be an integer from 0 to 12; and k′ may be an integer from 0 to 10.

The electrolytes may also contain a host of other stabilizing or electron shuttling additives. For example, the electrolyte may include a stabilizing agent. Such a stabilizing agent may be used to protect the electrodes, thereby lessening, or preventing subsequent performance degradation. Illustrative stabilizing agents include, but are not limited to, a spirocyclic hydrocarbon containing at least one oxygen atom and at least on alkenyl or alkynyl group, pyridazine, vinyl pyridazine, quinolone, pyridine, vinyl pyridine, 2,4-divinyl-tetrahydrooyran, 3,9-diethylidene-2,4,8-trioxaspiro[5,5]undecane, 2-ethylidene-5-vinyl-[1,3]dioxane, or a mixture of two or more thereof. In some embodiments, the electrolyte also includes redox shuttle materials. The shuttle, if present, will have an electrochemical potential above the positive electrode's maximum normal operating potential. Illustrative stabilizing agents include, but are not limited to, anisoles, 2,5-dimethyl-1,4-dimethoxybenzene, 2,3,5,6-tetramethyl-1,4-dimethoxybenzene, 2,5-di-tert-butyl-1,4-dimethoxybenzene, or a mixture of two or more thereof.

In some embodiments, the electrolyte further includes an additive that is an olefinic cyclic carbonate, fluorinated cyclic carbonate, lithium borate, organic sulfate, fluorinated organic sulfate, organic sulfite, organic sultone, or organic phosphonate. Illustrative, olefinic cyclic carbonates include, but are not limited to vinylene carbonate

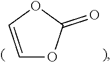

methyl vinylene carbonate

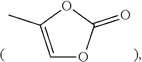

fluoroethylene carbonate, difluoroethylene carbonate, lithium difluoro(oxalato)borate, lithium bis(oxalato)borate, dioxathiolane-2,2-dioxide, ethylene sulfite, 1,3-propane sultone, or dimethyl methyl phosphonate. Illustrative, fluorinated organic sulfate include, but are not limited to 3-(trifluoromethyl)tetrahydrothiophene 1,1-dioxide

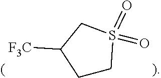 [SMILES: O=S1(=O)CCC(C(F)(F)F)C1]

In some embodiments, suitable electrode stabilizing additives include, but are not limited to 1,2-divinyl furoate, 1,3-butadiene carbonate, 1-vinylazetidin-2-one, 1-vinylaziridin-2-one, 1-vinylpiperidin-2-one, 1 vinylpyrrolidin-2-one, 2,4-divinyl-1,3-dioxane, 2 amino-3 vinylcyclohexanone, 2-amino-3-vinylcyclopropanone, 2 amino-4-vinylcyclobutanone, 2-amino-5-vinylcyclopentanone, 2-aryloxy-cyclopropanone, 2-vinyl-[1,2]oxazetidine, 2 vinylaminocyclohexanol, 2-vinylaminocyclopropanone, 2 vinyloxetane, 2-vinyloxy-cyclopropanone, 3-(N-vinylamino)cyclohexanone, 3,5-divinyl furoate, 3-vinylazetidin-2-one, 3 vinylaziridin 2 one, 3 vinylcyclobutanone, 3 vinylcyclopentanone, 3 vinyloxaziridine, 3 vinyloxetane, 3-vinylpyrrolidin-2-one, 4,4 divinyl-3 dioxolan 2-one, 4 vinyltetrahydropyran, 5-vinylpiperidin-3-one, allylglycidyl ether, butadiene monoxide, butyl vinyl ether, dihydropyran-3-one, divinyl butyl carbonate, divinyl carbonate, divinyl crotonate, divinyl ether, divinyl ethylene carbonate, divinyl ethylene silicate, divinyl ethylene sulfate, divinyl ethylene sulfite, divinyl methoxypyrazine, divinyl methylphosphate, divinyl propylene carbonate, ethyl phosphate, methoxy-o-terphenyl, methyl phosphate, oxetan-2-yl-vinylamine, oxiranylvinylamine, vinyl carbonate, vinyl crotonate, vinyl cyclopentanone, vinyl ethyl-2-furoate, vinyl ethylene carbonate, vinyl ethylene silicate, vinyl ethylene sulfate, vinyl ethylene sulfite, vinyl methacrylate, vinyl phosphate, vinyl-2-furoate, vinylcylopropanone, vinylethylene oxide, β-vinyl-γ-butyrolactone, or a mixture of any two or more thereof. In some embodiments the electrode stabilizing additive may be a cyclotriphosphazene that is substituted with F, alkyloxy, alkenyloxy, aryloxy, methoxy, allyloxy groups, or combinations thereof. For example, the additive may be a (divinyl)-(methoxy)(trifluoro)cyclotriphosphazene, (trivinyl)(difluoro)(methoxy)cyclotriphosphazene, (vinyl)(methoxy)(tetrafluoro)cyclotriphosphazene, (aryloxy)(tetrafluoro)(methoxy)-cyclotriphosphazene, (diaryloxy)(trifluoro)(methoxy)cyclotriphosphazene compounds, or a mixture of two or more such compounds. In some embodiments, the electrode stabilizing additive is vinyl ethylene carbonate, vinyl carbonate, or 1,2-diphenyl ether.

In other embodiments, the electrode stabilizing additives include compounds with phenyl, naphthyl, anthracenyl, pyrrolyl, oxazolyl, furanyl, indolyl, carbazolyl, imidazolyl, or thiophenyl groups. For example, electrode stabilizing additives may be aryloxpyrrole, aryloxy ethylene sulfate, aryloxy pyrazine, aryloxy-carbazole trivinylphosphate, aryloxy-ethyl-2-furoate, aryloxy-o-terphenyl, aryloxy-pyridazine, butyl-aryloxy-ether, divinyl diphenyl ether, (tetrahydro-furan-2-yl)-vinylamine, divinyl methoxybipyridine, methoxy-4-vinylbiphenyl, vinyl methoxy carbazole, vinyl methoxy piperidine, vinyl methoxypyrazine, vinyl methyl carbonate-allylanisole, vinyl pyridazine, 1-divinylimidazole, 3-vinyltetrahydrofuran, divinyl furan, divinyl methoxy furan, divinylpyrazine, vinyl methoxy imidazole, vinylmethoxy pyrrole, vinyl-tetrahydrofuran, 2,4-divinyl isooxazole, 3,4 divinyl-1-methyl pyrrole, aryloxyoxetane, aryloxy-phenyl carbonate, aryloxy-piperidine, aryloxy-tetrahydrofuran, 2-aryl-cyclopropanone, 2-diaryloxy-furoate, 4-allylanisole, aryloxy-carbazole, aryloxy-2-furoate, aryloxy-crotonate, aryloxy-cyclobutane, aryloxy-cyclopentanone, aryloxy-cyclopropanone, aryloxy-cycolophosphazene, aryloxy-ethylene silicate, aryloxy-ethylene sulfate, aryloxy-ethylene sulfite, aryloxy-imidazole, aryloxy-methacrylate, aryloxy-phosphate, aryloxy-pyrrole, aryloxyquinoline, diaryloxycyclotriphosphazene, diaryloxy ethylene carbonate, diaryloxy furan, diaryloxy methyl phosphate, diaryloxy-butyl carbonate, diaryloxy-crotonate, diaryloxy-diphenyl ether, diaryloxy-ethyl silicate, diaryloxy-ethylene silicate, diaryloxy-ethylene sulfate, diaryloxyethylene sulfite, diaryloxy-phenyl carbonate, diaryloxy-propylene carbonate, diphenyl carbonate, diphenyl diaryloxy silicate, diphenyl divinyl silicate, diphenyl ether, diphenyl silicate, divinyl methoxydiphenyl ether, divinyl phenyl carbonate, methoxycarbazole, or 2,4-dimethyl-6-hydroxy-pyrimidine, vinyl methoxyquinoline, pyridazine, vinyl pyridazine, quinoline, vinyl quinoline, pyridine, vinyl pyridine, indole, vinyl indole, triethanolamine, 1,3-dimethyl butadiene, butadiene, vinyl ethylene carbonate, vinyl carbonate, imidazole, vinyl imidazole, piperidine, vinyl piperidine, pyrimidine, vinyl pyrimidine, pyrazine, vinyl pyrazine, isoquinoline, vinyl isoquinoline, quinoxaline, vinyl quinoxaline, biphenyl, 1,2-diphenyl ether, 1,2-diphenylethane, o-terphenyl, N-methyl pyrrole, or naphthalene.

In yet other embodiments, the electrode stabilizing additives include substituted or unsubstituted spirocyclic hydrocarbons containing at least one oxygen atom and at least one alkenyl or alkynyl group. For example, such stabilizing additives include those having Formula VIII:

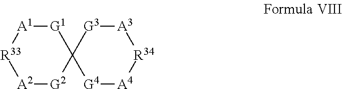

wherein A¹, A², A³, and A⁴ are independently O or CR³⁵R³⁶; provided that A¹ is not O when G¹ is O, A² is not O when G² is O, A³ is not O when G³ is O, and A⁴ is not O when G⁴ is O; G¹, G², G³, and G⁴ are independently O or CR³⁵R³⁶; provided that G¹ is not O when A¹ is O, G² is not O when A² is O, G³ is not O when A³ is O, and G⁴ is not O when A⁴ is 0; R³³ and R³⁴ are independently a substituted or unsubstituted divalent alkenyl or alkynyl group; and R³⁵ and R³⁶ at each occurrence are independently H, F, Cl, or a substituted or an unsubstituted alkyl, alkenyl, or alkynyl group.

Representative examples of Formula VIII include, but are not limited to, 3,9 divinyl-2,4,8,10-tetraoxaspiro[5.5]undecane, 3,9-divinyl-2,4,8-trioxaspiro[5.5]undecane, 3,9-divinyl-2,4-dioxaspiro[5.5]undecane, 3,9-diethylidene-2,4,8,10-tetraoxaspiro[5.5]undecane, 3,9 diethylidene-2,4,8-trioxaspiro[5.5]undecane, 3,9-diethylidene-2,4-dioxaspiro[5.5]undecane, 3,9-dimethylene-2,4,8,10-tetraoxaspiro[5.5]undecane, 3,9-divinyl-1,5,7,11-tetraoxaspiro[5.5]undecane, 3,9 dimethylene-1,5,7,11-tetraoxaspiro[5.5]undecane, 3,9 diethylidene-1,5,7,11-tetraoxaspiro[5.5]undecane, or a mixture of any two or more such compounds. Furthermore, mixtures of any two or more electrode stabilizing additives may also be used in the electrolytes of the present invention.

In some embodiments, the electrode stabilizing additive is an anion receptor. Anion receptors may include, but are not limited to, compounds such as tri(propyl)borate, tris(1,1,1,3,3,3-hexafluoro-propan-2-yl)borate, tris(1,1,1,3,3,3-hexafluoro-2-phenyl-propan-2-yl)borate, tris(1,1,1,3,3,3-hexafluoro-2-(trifluoromethyl)propan-2-yl)borate, triphenyl borate, tris(4-fluorophenyl)borate, tris(2,4-difluorophenyl)borate, tris(2,3,5,6-tetrafluorophenyl)borate, tris(pentafluorophenyl)borate, tris(3-(trifluoromethyl)phenyl)borate, tris(3,5-bis(trifluoromethyl)phenyl)borate, tris(pentafluorophenyl)borane, or a mixture of any two or more thereof. Further suitable additives include 2-(2,4-difluorophenyl)-4-fluoro-1,3,2-benzodioxaborole, 2-(3-trifluoromethyl phenyl)-4-fluoro-1,3,2-benzodioxaborole, 2,5-bis(trifluoromethyl)phenyl-4-fluoro-1,3,2-benzodioxaborole, 2-(4-fluorophenyl)-tetrafluoro-1,3,2-benzodioxaborole, 2-(2,4-difluorophenyl)-tetrafluoro-1,3,2-benzodioxaborole, 2-(pentafluorophenyl)-tetrafluoro-1,3,2-benzodioxaborole, 2-(2-trifluoromethyl phenyl)-tetrafluoro-1,3,2-benzodioxaborole, 2,5-bis(trifluoromethyl phenyl)-tetrafluoro-1,3,2-benzodioxaborole, 2-phenyl-4,4,5,5-tetra(trifluoromethyl)-1,3,2-benzodioxaborolane, 2-(3,5-difluorophenyl-4,4,5,5-tetrakis(trifluoromethyl)-1,3,2-dioxaborolane, 2-(3,5-difluorophenyl-4,4,5,5-tetrakis(trifluoromethyl)-1,3,2-dioxaborolane, 2-pentafluorophenyl-4,4,5,5-tetrakis(trifluoromethyl)-1,3,2-dioxaborolane, bis(1,1,1,3,3,3-hexafluoroisopropyl)phenyl-boronate, bis(1,1,1,3,3,3-hexafluoroisopropyl)-3, 5-difluorophenylboronate, bis(1,1,1,3,3,3-hexafluoroisopropyl) pentafluorophenylboronate, or a mixture of any two or more such compounds.

In some instances, the concentration of the electrode stabilizing additive in the electrolyte generally does not greatly exceed the concentration needed to form the passivation layer (i.e. SEI layer). As a result, the additives are generally present in smaller concentrations than the ionic electrolyte salts. A suitable concentration for an additive in the electrolyte includes, but is not limited to, concentrations greater than about 0.1 wt %, greater than about 0.5 wt % and/or less than about 5 wt %, less than about 20 wt %, or less than about 35 wt % where each of the wt % refers to the percentage of the total weight of solvent plus additive. In some embodiments, the concentration of the additive is less than about 3 wt %, or less than about 2 wt %. In yet other embodiments, a concentration of the electrolyte additive is from about 0.1 wt % to about 35 wt %, from about 0.1 wt % to about 30 wt %, from about 0.1 wt % to about 25 wt %, from about 0.1 wt % to about 20 wt %, from about 0.1 wt % to about 10 wt %, from about 0.1 wt % to about 5 wt %, from about 0.1 wt % to about 3 wt %, from about 0.1 wt % to about 2 wt %, from about 0.1 wt % to about 1 wt %, from about 0.5 wt % to about 10 wt %, from about 0.5 wt % to about 3 wt %, or from about 0.5 wt % to about 2 wt %.

In another aspect, the non-aqueous electrolyte includes an aprotic gel polymer carrier/solvent. Suitable gel polymer carrier/solvents include polyethers, polyethylene oxides, polyimides, polyphosphazines, polyacrylonitriles, polysiloxanes, polyether grafted polysiloxanes, derivatives of the foregoing, copolymers of the foregoing, crosslinked and network structures of the foregoing, blends of the foregoing, and the like, to which is added an appropriate ionic electrolyte salt. Other gel-polymer carrier/solvents include those prepared from polymer matrices derived from polypropylene oxides, polysiloxanes, sulfonated polyimides, perfluorinated membranes (Nafion™ resins), divinyl polyethylene glycols, polyethylene glycol-bis-(methyl acrylates), polyethylene glycol-bis(methyl methacrylates), derivatives of the foregoing, copolymers of the foregoing, crosslinked and network structures of the foregoing.

In another aspect, an electrochemical device is provided. The electrochemical devices include an anode, a cathode, and any of the electrolytes described herein that contain a compound of Formula I, II, III, IV, or V. In some embodiments, the compound is of Formula I. In other embodiments, the compound is of Formula II. In yet other embodiments, the compound is of Formula III. According to various embodiments, the electrochemical cells may be a lithium battery, a lithium-ion battery, a lithium-sulfur battery, a lithium-air battery, a sodium battery, a sodium-ion battery, a sodium-sulfur battery, a sodium-air battery, or a magnesium battery. In some embodiments, the electrochemical device is a lithium secondary cell. In some embodiments, the electrochemical device is a sodium secondary cell.

The electrochemical devices may include an anode which includes, but is not limited to, layered structured materials of graphitic, carbonaceous, metal oxide, silicon oxide, silicon-carbon composite, phosphorus-carbon composite, tin, tin alloys, silicon alloys, intermetallic compounds, lithium metal, sodium metal, or lithium titanium oxide. The anode may be stabilized by surface coating the active particles with a material. Hence the anodes can also include a surface coating of a metal oxide or fluoride such as ZrO₂, TiO₂, ZnO₂, WO₃, Al₂O₃, MgO, SiO₂, SnO₂, AlPO₄, Al(OH)₃, AlF₃, ZnF₂, MgF₂, TiF₄, ZrF₄, a mixture of any two or more thereof, of any other suitable metal oxide or fluoride. The anode may be further stabilized by surface coating the active particles with polymer materials. Examples of polymer coating materials include, but not limited to, polysiloxanes, polyethylene glycol, poly(3,4-ethylenedioxythiophene) polystyrene sulfonate, or a mixture of any two or more polymers.

In some embodiments, the anode of the electrochemical device includes natural graphite, synthetic graphite, hard carbon, amorphous carbon, soft carbon, mesocarbon microbeads, acetylene black, Ketjenblack®, carbon black, mesoporous carbon, porous carbon matrix, carbon nanotube, carbon nanofiber, graphene, silicon microparticle, silicon nanoparticle, silicon-carbon composite, tin microparticle, tin nanoparticle, tin-carbon composite, silicon-tin composite, phosphorous-carbon composites, lithium titanium oxide, lithium metal, sodium metal, lithium titanium oxide or magnesium metal.

The electrochemical devices may include a cathode that includes, but is not limited to, a spinel, an olivine, a carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{i+x′}NiₕMnₖCoₗMe²_{y′}O_{2-z′}F_{z′}, VO₂, or E_{x″}E′₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; E′ is Ti, V, Cr, Fe, or Zr; wherein 0x≤0.3; O≤y≤0.5; 0≤z≤0.5; 0≤m≤2; 0≤n≤2; 0≤x′0.4; 0≤α≤1; 0≤β≤1; 0≤γ≤1; 0≤h≤1; 0≤k≤1; 0≤l≤1; 0≤y′≤0.4; 0≤z′≤0.4; and 0≤x″≤3; with the proviso that at least one of h, k and 1 is greater than 0. In some embodiments, the cathode includes, but is not limited to, NaₓVO₂, NaMeO₂, and Na_{1-y}FePO₄; wherein 0≤x≤2; 0≤y≤1; Me is Al, Mg, Ti, B, Ga, Si, Ni, Mn, or Co; or an electrode material with composition NaₐLi_{b}Ni_{c}Mn_{d}MₑO_{f}, wherein M is a metal cation selected from Co and Mg, 0≤a≤1, 0≤b≤1, 0≤c≤1, 0≤d≤1, 0≤e≤1, 1≤f≤2. In some embodiments, the positive electrode includes Na_{w}MnₓNi_{y}Co_{z}O₂ wherein w, x, y, and z satisfy the relations 0<w<1.5, 0≤x<1, 0≤y<1, 0≤z<1, and x+y+z=1. In some embodiments, the positive electrode includes Na_{w}MeₓO₂ wherein Me is any transition metal and w and x satisfy the relations 0<w<1.5, 0≤x<1.

The cathode may be further stabilized by surface coating the active particles with a material that can neutralize acid or otherwise lessen or prevent leaching of the transition metal ions. The cathodes may also include a surface coating of a metal oxide or fluoride such as ZrO₂, TiO₂, ZnO₂, WO₃, Al₂O₃, MgO, SiO₂, SnO₂, AlPO₄, Al(OH)₃, AlF₃, ZnF₂, MgF₂, TiF₄, ZrF₄, LiMPO₄ or LiMBO₃, where in M indicates transition metal such as but not limited to Ni, Mn, Co, or a mixture of any two or more thereof, or of any other suitable metal oxide or fluoride. The coating can be applied to a carbon coated cathode. The cathode may be further stabilized by surface coating the active particles with polymer materials. Examples of polymer coating materials include, but not limited to, polysiloxanes, polyethylene glycol, or poly(3,4-ethylenedioxythiophene) polystyrene sulfonate, a mixture of any two or more polymers.

The electrodes of the electrochemical devices may also include a current collector. Current collectors for either the anode or the cathode may include, but are not limited to, those of copper, stainless steel, titanium, tantalum, platinum, gold, aluminum, nickel, cobalt, cobalt nickel alloy, highly alloyed ferritic stainless steel containing molybdenum and chromium; or nickel-, chromium-, or molybdenum containing alloys. The electrodes (i.e., the cathode and/or the anode) may also include a conductive polymer as a binder. Illustrative conductive polymers include, but not limited to, polyaniline, polypyrrole, poly(pyrrole-co-aniline), polyphenylene, polythiophene, polyacetylene, polysiloxane, or polyfluorene.

The electrochemical device disclosed herein also includes a porous separator to separate the cathode from the anode to prevent, or at least minimize, short-circuiting in the device. The separator may be a polymer or ceramic or mixed separator. The separator may include, but is not limited to, polypropylene (PP), polyethylene (PE), trilayer (PP/PE/PP), or polymer films that may optionally be coated with alumina-based ceramic particles.

The present invention, thus generally described, will be understood more readily by reference to the following examples, which are provided by way of illustration and are not intended to be limiting of the present invention.

### EXAMPLES

Example 1: Synthesis of ((4,5-dihydrofuran-2-yl)oxy)trimethylsilane (GBLTMS). GBLTMS was synthesized via the synthetic pathway as depicted in Scheme 1. To a solution of diisopropylamine (15.4 mL, 110 mmol) in THE (100 mL) was dropwise added n-butyllithium (58 mL, 1.6 M in hexanes, 93 mmol) at 0° C. under an argon atmosphere, and the mixture was stirred for 30 min at 0° C. Gamma-butyrolactone (5 mL, 65.6 mmol) was added to the solution of lithium diisopropylamide at 0° C., and the reaction mixture was stirred for 1 h at 0° C. Trimethylsilyl chloride (12.4 mL, 98 mmol) was then added to the reaction mixture at 0° C. After stirring for 1 h at 0° C., the mixture was filtered and the solvents were removed by a rotary evaporator (“rotavap”). The crude product was then purified by vacuum distillation twice to provide 1.76 g (17%) of GBLTMS as a colorless liquid. The GBLTMS was characterized by ¹H and ¹³C NMR to confirm its structure. H NMR (300 MHz, CDCl₃) δ 0.23 (s, 9H), 2.61 (td, J=8.9, 2.2 Hz, 2H), 3.66 (t, J=2.2 Hz, 1H), 4.28 (t, J=9.1 Hz, 2H); ¹³C NMR (CDCl₃, 75 MHz): δ−0.32, 28.3, 67.7, 67.9, 158.6.

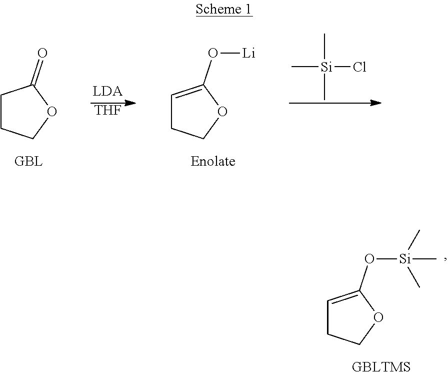

Example 2: Synthesis of ((1-methoxyprop-1-en-1-yl)oxy)trimethylsilane (“OMeOTMSPE”). OMeOTMSPE was synthesized via the synthetic pathway as depicted in Scheme 2. To a solution of diisopropylamine (12.3 mL, 88 mmol) in THE (80 mL) was dropwise added n-butyllithium (46 mL, 1.6 M in hexanes, 74 mmol) at 0° C. under an argon atmosphere, and the mixture was stirred for 30 min at 0° C. Methyl propionate (5 mL, 51.9 mmol) was added to the solution of lithium diisopropylamide at 0° C., and the reaction mixture was stirred for 1 h at 0° C. Trimethylsilyl chloride (9.9 mL, 78 mmol) was then added to the reaction mixture at 0° C. After stirring for 1 h at 0° C., the mixture was filtered and the solvents were removed by rotavap. The crude product was then purified by vacuum distillation twice to provide 1.25 g (15%) of OMeOTMSPE as a colorless liquid. The OMeOTMSPE was characterized by ¹H and ¹³C NMR to confirm its structure. ¹H NMR (300 MHz, CDCl₃) δ 0.05 (s, 9H), 1.12 (d, J=7.1 Hz, 3H), 2.04 (q, J=7.2 Hz, 1H), 3.62 (s, 3H); ¹³C NMR (CDCl₃, 75 MHz): δ−3.0, 10.9, 30.1, 51.0, 176.7.

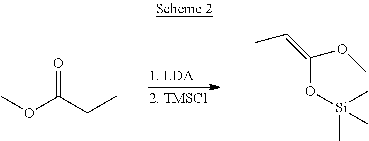

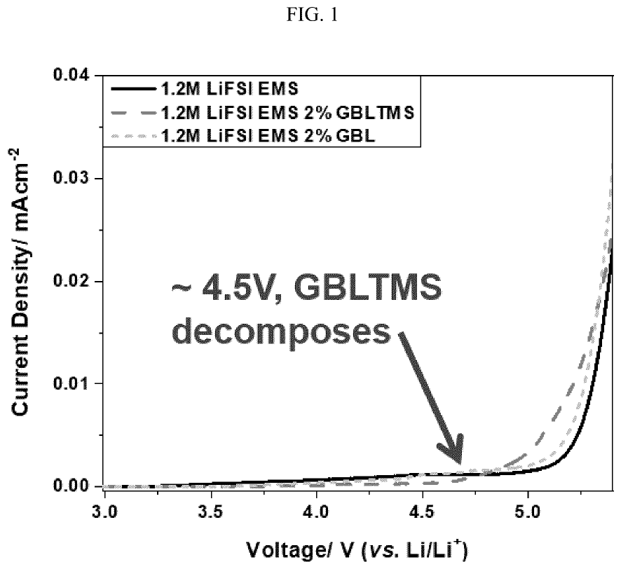

Example 3. FIG. 1 shows the linear sweep voltammograms of electrolytes of linear sweep voltammograms for (A) 1.2 M LiFSI EMS (ethyl methyl sulfone); (B) 1.2 M LiFSI EMS with 2 wt. % GBL (gamma butyrolactone); and (C) 1.2 M LiFSI EMS with 2 wt. % GBLTMS, using a 2023 coin cell system (aluminum working electrode, lithium counter electrode and reference electrode). For the 1.2 M LiFSI EMS electrolyte, the oxidation reaction was triggered at about 5.1 V vs. Li. For the 1.2 M LiFSI EMS with 2 wt. % GBL electrolyte, the oxidation reaction was triggered at the same potential about 5.1 V vs. Li. Finally, for the 1.2 M LiFSI EMS with 2 wt. % GBLTMS electrolyte, the oxidation reaction was triggered at about 4.5 V vs. Li. Therefore, the GBL-added electrolyte shows no significant decomposition in the EMS electrolyte. On the contrary, the GBLTMS-added electrolyte oxidized at a significantly lower potential, indicating a preferential decomposition, which can form a robust cathode-electrolyte interphase to protect the cathode material.

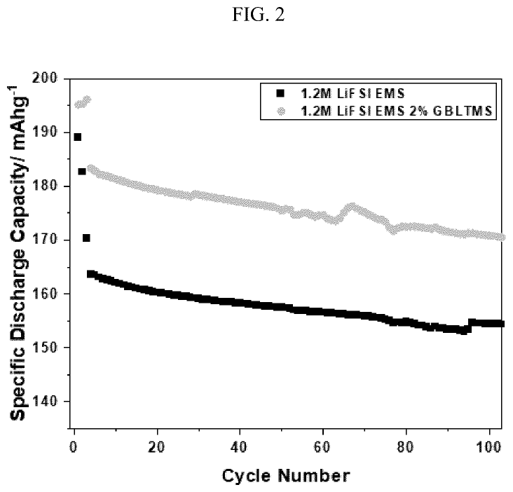

Example 4. Cycling performance. 2032 coin cells were prepared with a LiNi_{0.8}Mn_{0.1}Co_{0.1}O₂ (NMC811) cathode, an A12 graphite anode, and various electrolytes. The electrolytes included (A) 1.2 M LiFSI EMS; and (C) 1.2 M LiFSI EMS with 2 wt. % GBLTMS. FIG. 2 depicts the discharge capacity for the cells with electrolytes A and C. The coin cells were cycled from 3.0 V to 4.5 V at a current of C/2. The cell with the GBLTMS-added electrolyte show much better cycling performance than the cell just using the 1.2 M LiFSI EMS electrolyte.

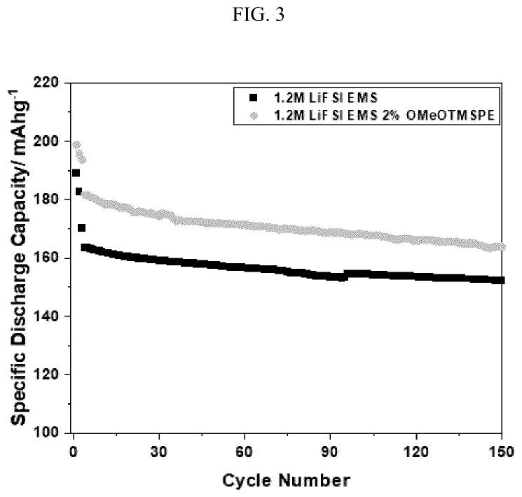

Example 5. Cycling performance. 2032 coin cells were prepared with a LiNi_{0.8}Mn_{0.1}Co_{0.1}O₂ (NMC811) cathode, an A12 graphite anode, and various electrolytes. The electrolytes included (A) 1.2 M LiFSI EMS; and (D) 1.2 M LiFSI EMS with 2 wt. % OMeOTMSPE. FIG. 3 depicts the discharge capacity for the cells with electrolytes A and D. The coin cells were cycled from 3.0 V to 4.5 V at a current of C/2. The cell with the OMeOTMSPE-added electrolyte show much better cycling performance than the cell just using the 1.2 M LiFSI EMS electrolyte.

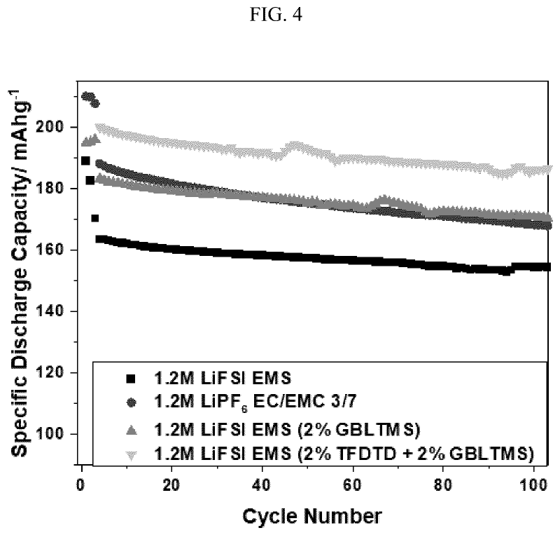

Example 6. Cycling performance. 2032 coin cells were prepared with a LiNi_{0.8}Mn_{0.1}Co_{0.1}O₂ (NMC811) cathode, an A12 graphite anode, and various electrolytes. The electrolytes included (A) 1.2 M LiFSI EMS; (E) 1.2M LiPF6 in a 3:7 (wt/wt) mixture of ethylene carbonate (“EC”) and ethylmethyl carbonate (“EMC”) (“GEN2”); (C) 1.2 M LiFSI EMS with 2 wt. % GBLTMS; and (F) 1.2 M LiFSI EMS with 2 wt. % GBLTMS plus 2 wt. % 3-(trifluoromethyl)tetrahydrothiophene 1,1-dioxide (TFDTD). FIG. 4 depicts the discharge capacity for the cells with electrolytes A, C, E, and F. The coin cells were cycled from 3.0 V to 4.5 V at a current of C/2. The cell with the 1.2 M LiFSI EMS with 2 wt. % GBLTMS electrolyte show similar cycling performance to the cell using the GEN2-based electrolyte, while the cell using 1.2 M LiFSI EMS with 2 wt. % GBLTMS plus 2 wt. % TFDTD electrolyte achieves the best cycling performance, demonstrating a significant synergistic effect.

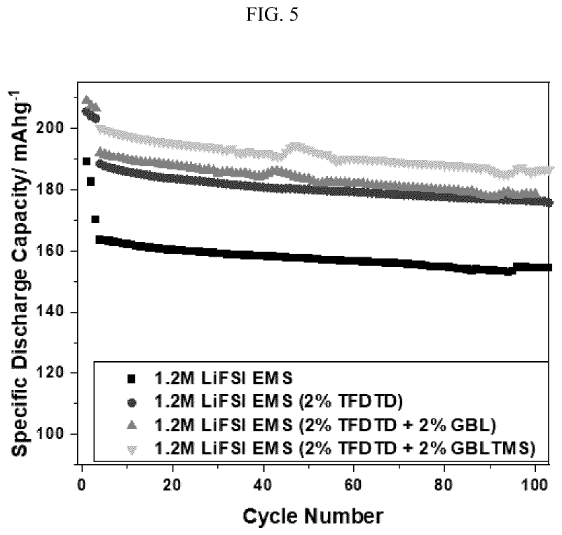

Example 7. Cycling performance. 2032 coin cells were prepared with a LiNi_{0.8}Mn_{0.1}Co_{0.1}O₂ (NMC811) cathode, an A12 graphite anode, and various electrolytes. The electrolytes included (A) 1.2 M LiFSI EMS; (G) 1.2 M LiFSI EMS with 2 wt. % TFDTD; (H) 1.2 M LiFSI EMS with 2 wt. % GBL plus 2 wt. % TFDTD; and (F) 1.2 M LiFSI EMS with 2 wt. % GBLTMS plus 2 wt. % TFDTD. FIG. 5 depicts the discharge capacity for the cells with electrolytes A, C, E, and F. The coin cells were cycled from 3.0 V to 4.5 V at a current of C/2. The cell with the 1.2 M LiFSI EMS with 2 wt. % TFDTD electrolyte shows similar cycling performance to the cell using the 1.2 M LiFSI EMS with 2 wt. % GBL plus 2 wt. % TFDTD electrolyte, suggesting there is no effect upon the addition of GBL. While the cell using 1.2 M LiFSI EMS with 2 wt. % GBLTMS plus 2 wt. % TFDTD electrolyte displays the best cycling performance, demonstrating that only the use of GBLTMS and TFDTD shows significant synergistic effect.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A non-aqueous electrolyte comprising:
a salt; and
a compound of Formula (I), Formula (II), Formula (III), Formula (IV), Formula (V), or a mixture of any two or more thereof: 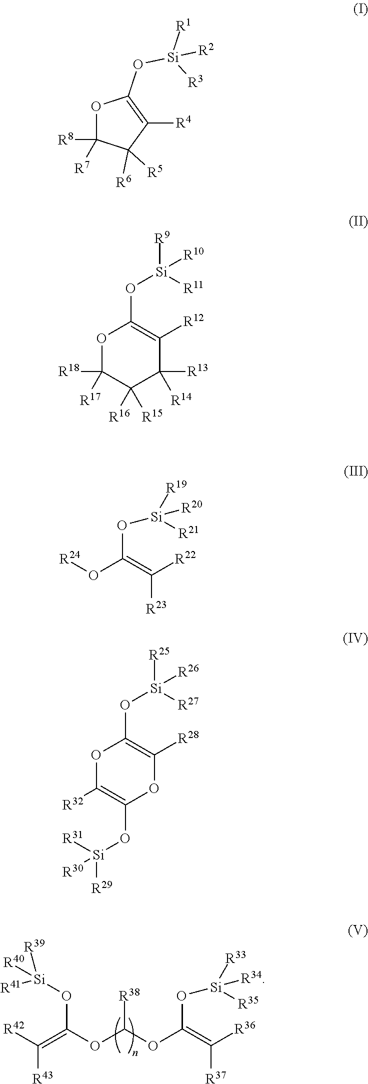
wherein:
R¹, R², R³, R⁹, R¹⁰, R¹¹, R¹⁹, R²⁰, R²¹, R²⁵, R²⁶, R²⁷, R²⁹, R³⁰, R³¹, R³³, R³⁴, R³⁵, R³⁹, R⁴⁰, and R⁴¹ are individually H, F, alkyl, alkenyl, alkynyl, aryl, aralkyl, heteroaryl, heteroarylalkyl, heterocyclylalkyl, heterocyclylalkyl, cycloalkyl, cycloalkylalkyl, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂;
R⁴, R⁵, R⁶, R⁷, R⁸; R¹², R¹³, R¹⁴, R¹⁵, R¹⁶, R¹⁷, R¹⁸, R²², R²³, R²⁴, R²⁸, R³², R³⁶, R³⁷, R³⁸, R⁴², and R⁴³ are individually H, F, alkyl, alkenyl, alkynyl, aryl, aralkyl, heteroaryl, heteroarylalkyl, heterocyclylalkyl, heterocyclylalkyl, cycloalkyl, cycloalkylalkyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂;
n is 0, 1, 2, 3, 4, or 5; and
any of the alkyl, aryl, aralkyl, heteroaryl, heterocyclyl, alkenyl, or alkynyl groups are substituted or unsubstituted.

2. The non-aqueous electrolyte of claim 1, wherein when the compound is of Formula (I):
R¹, R², and R³ are individually C₁₋₆ alkyl, —(CR⁷¹₂)ₚO(C₁-C₆ alkyl), —(CR⁷¹₂)ₚO(C₁-C₆ aryl), or —(CR^{w}₂)ₚO(C₁-C₆ aralkyl);
R⁴, R⁵, R⁶, R⁷, and R⁸ are each individually H, F, OR⁷², or C₁₋₆ alkyl;
each R⁷¹ is individually H or F;
each R⁷² is H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂;
R⁷⁰ is H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and
p is 1, 2, or 3.

3. The non-aqueous electrolyte of claim 1, wherein when the compound is of Formula (I):
R¹, R², and R³ are individually methyl, ethyl, or benzyl; and
R⁴, R⁵, R⁶, R⁷, and R⁸ are each H.

4. The non-aqueous electrolyte of claim 1, wherein when the compound is of Formula (I):
R¹, R², and R³ are individually C₁₋₆ fluorinated alkyl, C₁₋₆ fluorinated alkenyl, or C₁₋₆ fluorinated alkynyl; and
R⁴, R⁵, R⁶, R⁷, and R⁸ are C₁₋₆ fluorinated alkyl or H.

5. The non-aqueous electrolyte of claim 1, wherein when the compound is of Formula (I):
R¹, R², and R³ are individually —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃; and
R⁴, R⁵, R⁶, R⁷, and R⁸ are individually H, —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃.

6. The non-aqueous electrolyte of claim 1, wherein when the compound is of Formula (II):
R⁹, R¹⁰, and R¹¹ are individually C₁₋₆ alkyl, —(CR⁷¹₂)ₚO(C₁-C₆ alkyl), —(CR⁷¹₂)ₚO(C₁-C₆ aryl), or —(CR^{w}₂)ₚO(C₁-C₆ aralkyl);
R¹², R¹³, R¹⁴, R¹⁵, R¹⁶, R¹⁷, and R¹⁸ are each individually H, F, OR⁷², or C₁₋₆ alkyl;
each R⁷¹ is individually H or F;
each R⁷² is H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂;
R⁷⁰ is H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and
p is 1, 2, or 3.

7. The non-aqueous electrolyte of claim 1, wherein when the compound is of Formula (II):
R⁹, R¹⁰, and R¹¹ are individually methyl, ethyl, or benzyl; and
R¹², R¹³, R¹⁴, R¹⁵, R¹⁶, R¹⁷, and R¹⁸ are each H.

8. The non-aqueous electrolyte of claim 1, wherein when the compound is of Formula (II):
R⁹, R¹⁰, and R¹¹ are individually C₁₋₆ fluorinated alkyl, C₁₋₆ fluorinated alkenyl, or C₁₋₆ fluorinated alkynyl; and
R¹², R¹³, R¹⁴, R¹⁵, R¹⁶, R¹⁷, and R¹⁸ are C₁₋₆ fluorinated alkyl or H.

9. The non-aqueous electrolyte of claim 1, wherein when the compound is of Formula (II):
R⁹, R¹⁰, and R¹¹ are individually —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃; and
R¹², R¹³, R¹⁴, R¹⁵, R¹⁶, R¹⁷, and R¹⁸ are individually H, —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃.

10. The non-aqueous electrolyte of claim 1, wherein when the compound is of Formula (III):
R¹⁹, R²⁰, and R²¹ are individually C₁₋₆ alkyl, —(CR⁷¹₂)ₚO(C₁-C₆ alkyl), —(CR⁷¹₂)ₚO(C₁-C₆ aryl), or —(CR^{w}₂)ₚO(C₁-C₆ aralkyl);
R²², R²³, and R²⁴ are each H, F, OR⁷², or C₁₋₆ alkyl;
each R⁷¹ is individually H or F;
each R⁷² is H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂;
R⁷⁰ is H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and
p is 1, 2, or 3.

11. The non-aqueous electrolyte of claim 1, wherein when the compound is of Formula (III):
R¹⁹, R²⁰, and R²¹ are individually methyl, ethyl, or benzyl; and
R²², R²³, and R²⁴ are each H.

12. The non-aqueous electrolyte of claim 1, wherein when the compound is of Formula (III):
R¹⁹, R²⁰, and R²¹ are individually C₁₋₆ fluorinated alkyl, C₁₋₆ fluorinated alkenyl, or C₁₋₆ fluorinated alkynyl; and
R²², R²³, and R²⁴ are C₁₋₆ fluorinated alkyl or H.

13. The non-aqueous electrolyte of claim 1, wherein when the compound is of Formula (III):
R¹⁹, R²⁰, and R²¹ are individually —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃; and
R²², R²³, and R²⁴ are individually H, —CH₃, —CFH₂, —CF₂H, —CF₃, —CH₂CH₃, —CFHCH₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CHCH₂, —CFCH₂, —CHCFH, —CHCF₂, —CFCFH, —CFCF₂, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆F₅, —CH₂OC₆F₅; —CH₂CH₂CH₂CH₃, —CH(CH₃)₂, —CH₂CH₂(CH₃)₂, —CH₂OCH₃, —C₆H₅, —CH₂OC₆H₅, —CH₂OCH₂CH₃, —CH₂OCH(CH₃)₂, —C(CH₃)HOCH₃, —CH₂CH₂OCH₃, or —CH₂CH₂OCH₂CH₃.

14. The non-aqueous electrolyte of claim 1 further comprising an additive that is 3-(trifluoromethyl)tetrahydrothiophene 1,1-dioxide, vinylene carbonate, methyl vinylene carbonate, fluoroethylene carbonate, difluoroethylene carbonate, lithium difluoro(oxalato)borate, lithium bis(oxalato)borate, dioxathiolane-2,2-dioxide, ethylene sulfite, 1,3-propane sultone, or dimethyl methyl phosphonate.

15. The non-aqueous electrolyte of claim 1, wherein the compound is present in the electrolyte from greater than 0 wt % up to 20 wt % based upon the total weight of the electrolyte.

16. The non-aqueous electrolyte of claim 1 further comprising a non-aqueous solvent.

17. The non-aqueous electrolyte of claim 1, wherein when the compound is of Formula (IV):
R²⁵, R²⁶, R²⁷, R²⁹, R³⁰, and R³¹ are individually C₁₋₆ alkyl, —(CR⁷¹₂)ₚO(C₁-C₆ alkyl), —(CR⁷¹₂)ₚO(C₁-C₆ aryl), or —(CR^{w}₂)ₚO(C₁-C₆ aralkyl);
R²⁸, and R³² are each H, F, OR⁷², or C₁₋₆ alkyl;
each R⁷¹ is individually H or F;
each R⁷² is H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂;
R⁷⁰ is H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and
p is 1, 2, or 3.

18. The non-aqueous electrolyte of claim 1, wherein when the compound is of Formula (V):
R³³, R³⁴, R³⁵, R³⁸, R³⁹, R⁴⁰, and R⁴¹ are individually C₁₋₆ alkyl, —(CR⁷¹₂)ₚO(C₁-C₆ alkyl), —(CR⁷¹₂)ₚO(C₁-C₆ aryl), or —(CR^{w}₂)ₚO(C₁-C₆ aralkyl);
R³⁶, R³⁷, R⁴², and R⁴³ are each H, F, OR⁷², or C₁₋₆ alkyl;
each R⁷¹ is individually H or F;
each R⁷² is H, —C(O)R⁷⁰, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂;
R⁷⁰ is H, alkyl, aryl, aralkyl, heteroaryl, heterocyclyl, alkenyl, alkynyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂; and
p is 1, 2, or 3

19. An electrochemical cell comprising:
an anode;
a cathode; and
a non-aqueous electrolyte comprising:
a salt;
a non-aqueous solvent; and
from greater than 0 wt % to about 20 wt % of a compound of Formula (I), Formula (II), Formula (III), Formula (IV), Formula (V) or a mixture of any two or more thereof: 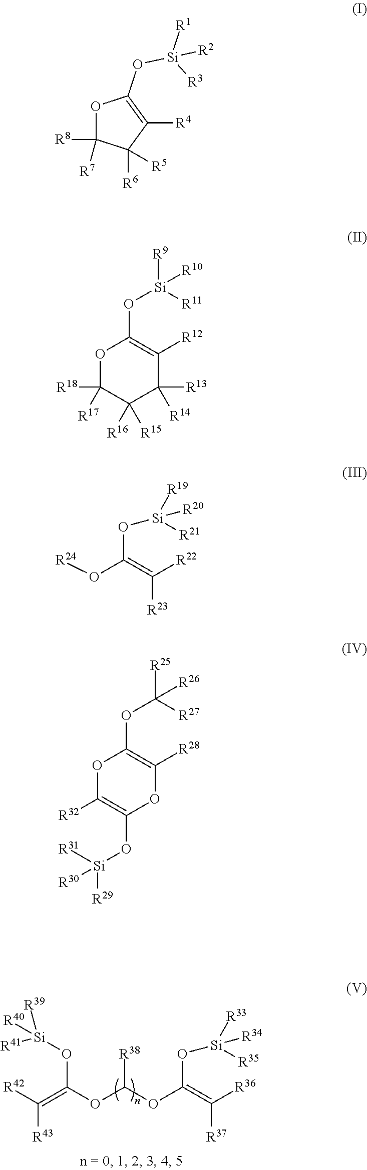
R¹, R², R³, R⁹, R¹⁰, R¹¹, R¹⁹, R²⁰, R²¹, R²⁵, R²⁶, R²⁷, R²⁹, R³⁰, R³¹, R³³, R³⁴, R³⁵, R³⁸, R³⁹, R⁴⁰, and R⁴¹ are individually H, F, alkyl, alkenyl, alkynyl, aryl, aralkyl, heteroaryl, heteroarylalkyl, heterocyclylalkyl, heterocyclylalkyl, cycloalkyl, cycloalkylalkyl, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂;
R⁴, R⁵, R⁶, R⁷, R⁸; R¹², R¹³, R¹⁴, R¹⁵, R¹⁶, R¹⁷, R¹⁸, R²², R²³, R²⁴, R²⁸, R³², R³⁶, R³⁷, R³⁸, R⁴², and R⁴³ are individually H, F, alkyl, alkenyl, alkynyl, aryl, aralkyl, heteroaryl, heteroarylalkyl, heterocyclylalkyl, heterocyclylalkyl, cycloalkyl, cycloalkylalkyl, silyl, siloxy, an ether, a polyalkylene glycol, —CFH₂, —CF₂H, —CF₃, —CF₂CF₃, —CF₂CHF₂, —CF₂CH₃, —CF₂CH₂F, —CHFCF₃, —CHFCHF₂, —CHFCH₃, —CHFCH₂F, —CH₂CF₃, —CH₂CHF₂, —CH₂CH₂F, —CF(CF₃)₂, or —CH(CF₃)₂;
n is 0, 1, 2, 3, 4, or 5; and
any of the alkyl, aryl, aralkyl, heteroaryl, heterocyclyl, alkenyl, or alkynyl groups are substituted or unsubstituted.

20. The electrochemical cell of claim 19, wherein the anode comprises graphite, synthetic graphite, hard carbon, amorphous carbon, soft carbon, mesocarbon microbeads, acetylene black, Ketjenblack®, carbon black, mesoporous carbon, porous carbon matrix, carbon nanotube, carbon nanofiber, graphene, silicon microparticle, silicon nanoparticle, silicon-carbon composite, tin microparticle, tin nanoparticle, tin-carbon composite, silicon-tin composite, phosphorous-carbon composites, lithium titanium oxide, lithium metal, sodium metal, lithium titanium oxide, magnesium metal, or a mixture of any two or more thereof.
